(19) United States
(12) Patent Application Publication
(10) Pub. No.: US 2012/0137809 A1
(43) Pub. Date: Jun. 7, 2012

(54) DECELERATOR FOR GENERATING BOOMING SOUND

(75) Inventor: Dae Woon Kim, Anyang (KR)

(73) Assignee: HYUNDAI MOTOR COMPANY, Seoul (KR)

(21) Appl. No.: 13/172,743

(22) Filed: Jun. 29, 2011

(30) Foreign Application Priority Data
Dec. 1, 2010 (KR) 10-2010-0121630

(51) Int. Cl. F16H 55/00

(52) U.S. Cl. 74/431

(57) ABSTRACT

The present invention relates to a decelerator for generating a booming sound. In particular, the present invention includes a shaft connected with a motor; an input (first) gear engaged in the input shaft, and an output (second) gear mated with the input gear. The motor controls the vehicle speed and delivers the torque of the output (second) gear which is characterized in that output gear further includes an unbalanced drive (third) gear installed on the shaft spaced a predetermined distance from the input (first) gear. Further, an unbalanced driven (fourth) gear is mated with the unbalanced drive (third) gear, and an unbalanced module, having an unbalanced mass, is connected with the unbalanced driven (fourth) gear.

### CROSS-REFERENCE TO RELATED APPLICATION

This application claims priority to and the benefit of Korean Patent Application No. 10-2010-0121630 filed in the Korean Intellectual Property Office on Dec. 1, 2010, the entire contents of which are incorporated herein by reference.

### BACKGROUND OF THE INVENTION

(a) Field of the Invention

The present invention relates to a vehicle decelerator that is driven by a motor. More particularly, the present invention relates to a decelerator for generating a booming sound, that is installed with an unbalanced module having an unbalanced mass, and that generates the booming sound by rotating the unbalanced module.

(b) Description of the Related Art

In an electric and fuel cell vehicles, which are currently under development as environmentally friendly vehicles, a motor generates a driving torque instead of a general engine, and the electric vehicles have a structure in which the driving torque is delivered to a vehicle drive shaft by converting torque and rotation speed by a decelerator having an appropriate gear ratio.

Electrical energy to drive the motor in an electric vehicle is supplied from a battery, and a fuel cell vehicle uses electrical energy generated from a hydrogen fuel cell. Interior noise while driving a vehicle greatly influences the emotions of a driver and is a significant factor that determines satisfaction about the vehicle.

The overall sound pressure of a motor-driven vehicle in this respect is much more advantageous than that of an engine-driven vehicle. However, only a sharp whining sound is created by operation of the motor and thus, drivers have difficulty with this sound.

Conventional engine noise has a higher sound pressure than that of an electric vehicle, but the booming sound is moderately added and a dynamic and sporty engine sound compared with a motor-driven vehicle can be created, so the driver can be interested in driving the vehicle. However, consumers can lose interest in driving because of the deficiency of the dynamic sound compared with the conventional engine-driven vehicle if many electric vehicles are manufactured.

To resolve this problem, active sound design (ASD) has been used, and the principle, as shown in FIG. 1, includes generating an imaginary sound that the driver enjoys by using a power source 10, a microphone 50, a speaker 20, an amplifier 30, and a controller 40. However, this art is generally only applied to high grade vehicles, and the system is complicated and very expensive.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a decelerator for generating a booming sound which generates a booming sound by installing an unbalanced drive gear on an input shaft connected with a motor and an unbalanced module having an unbalanced mass.

An exemplary embodiment of the present invention to accomplish this by providing a decelerator for generating a booming sound, including: an input shaft connected with a motor; an input gear engaged with the input shaft; and an output gear mated with the input gear, wherein the motor controlling the vehicle speed and delivering torque of the output gear is characterized in that it further includes an unbalanced drive gear installed on the input shaft spaced from the input gear, an unbalanced driven gear mated with the unbalanced drive gear, and an unbalanced module connected with the unbalanced driven gear and having an unbalanced mass.

An unbalanced module according to the exemplary embodiment of the present invention can include an unbalanced shaft connected with the unbalanced driven gear, an unbalanced mass adhered on a side of the unbalanced shaft, and a bearing installed on the exterior circumference of the unbalanced shaft and supporting the unbalanced shaft.

The booming sound according to the exemplary embodiment of the present invention can be adjusted by the rotation speed of the unbalanced shaft and the rotation speed of the unbalanced shaft is adjusted by the gear ratio between the unbalanced drive gear and the unbalanced driven gear. Additionally, booming sound according to the exemplary embodiment of the present invention can be adjusted by the weight of the unbalanced mass. This bearing can be either a ball bearing or a metal bearing.

As described above, while the conventional ASD art needs many components such as a microphone, a speaker, an amplifier, a controller, etc., and needs time to develop a program, and imaginary sound to be generated thereby, the sound of the present invention is more real because of the booming sound generated by real mechanical vibration using the unbalanced module having the unbalanced mass and a simple structure incorporated therewith, and thus the present invention is much more cost effective.

### BRIEF DESCRIPTION OF THE DRAWINGS

The above and other features of the present invention will now be described in detail with reference to certain exemplary embodiments thereof illustrated the accompanying drawing which is given hereinbelow by way of illustration only, and thus are not limitative of the present invention, and wherein:

FIG. 1 is a schematic diagram of a conventional ASD art.

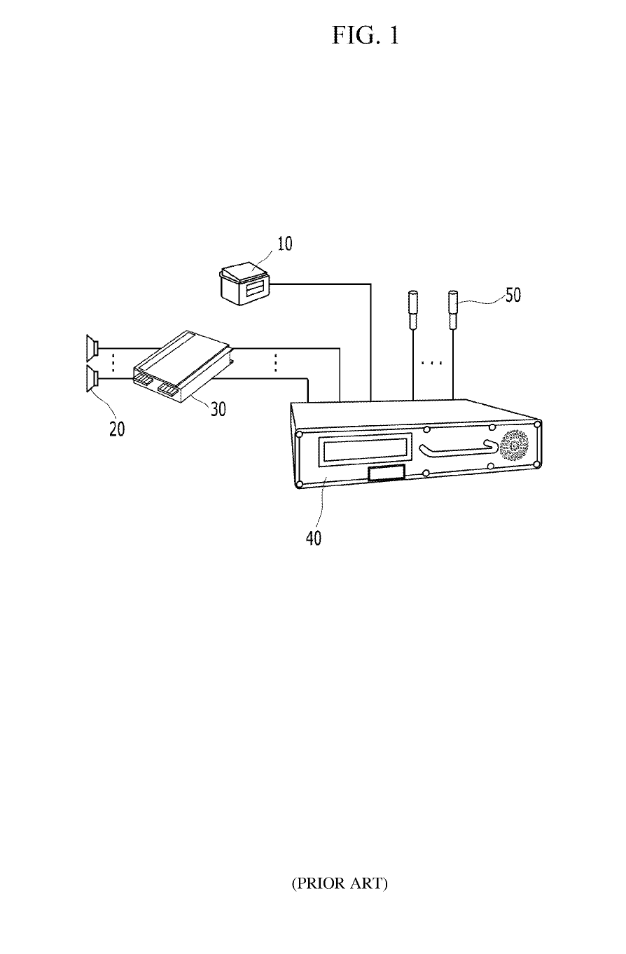

FIG. 2 is a schematic view of an unbalanced module according to an illustrative embodiment of the present invention.

FIG. 3 is a graph showing the relationship between a rotation speed of the unbalanced shaft and vibration frequency.

FIG. 4 is a schematic view of the decelerator combined with the unbalanced module.

FIG. 5 is a schematic view of the unbalanced module, an unbalanced driven gear, and an unbalanced drive gear according to the illustrative embodiment of the present invention.

### DETAILED DESCRIPTION OF THE EMBODIMENTS

Hereinafter, exemplary embodiments of the present invention will be described referring to accompanying drawings in order for a person having ordinary skill in the art to which said subject matter pertains to easily carry out the present invention.

Note that it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

In the exemplary embodiment according to the present invention, an unbalanced module is equipped in a decelerator of a conventional motor-driven electric vehicle to generate a booming sound in a motor-driven electric vehicle, a hybrid vehicle, etc.

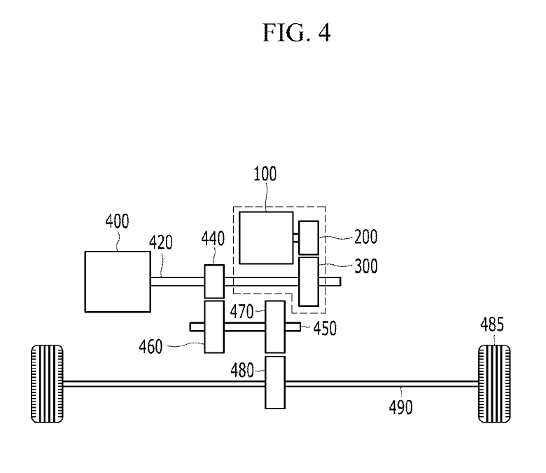

A decelerator of the motor-driven vehicle, as shown in FIG. 4, includes an input gear 440 that is connected with a drive motor 400 and can rotate thereby, an output gear 460 mated with the input gear 440 and receiving power from the input gear 440, an output shaft 450 that is engaged with the output gear 460 and can rotate using the power delivered to the output gear 460, an output shaft gear 470 that is connected with the output shaft 450 and formed at predetermined intervals with the output gear 460 and formed parallel to the output shaft 450, and a differential gear 480 mated with the output shaft gear 470.

The power that is transferred to the differential gear 480 by the decelerator is transferred to a drive shaft 490 connected to the differential gear 480, and the power is transferred to a wheel 485. The speed of the vehicle can be controlled through this path.

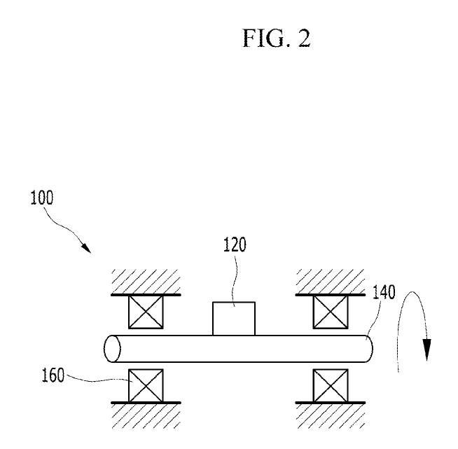

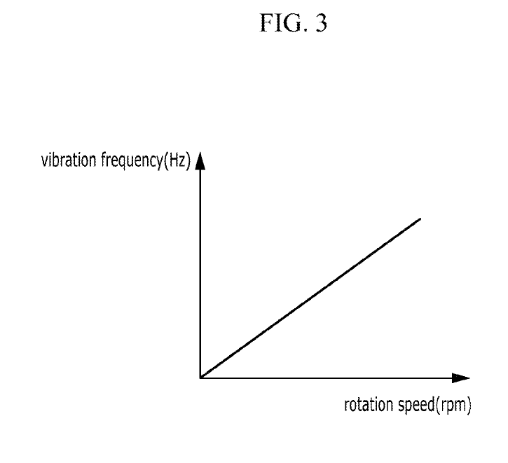

An exemplary embodiment according to the present invention uses an unbalanced mass 120 to generate a booming sound, as shown in FIG. 2. The unbalanced mass 120 is adhered on a side of an unbalanced shaft 140 so a vibration is created by rotating the unbalanced mass 120 according to the rotation of the unbalanced shaft 140. A generated imbalance vibration creates a booming sound in a vehicle by vibrating a vehicle body, and the rotation speed of the unbalanced shaft 140 and vibration frequency are as shown in FIG. 3.

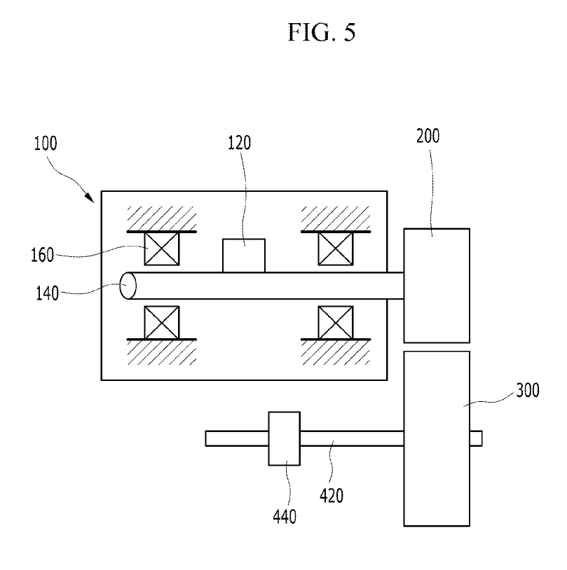

FIG. 5 shows a schematic view of an unbalanced module 100 according to the exemplary embodiment of the present invention, wherein an unbalanced drive gear 300 in the present invention is formed on an input shaft 420 to install the unbalanced module 100, and an unbalanced driven gear 200 is equipped by being mated with the unbalanced drive gear 300 and transferring the torque of the input shaft 420 to the unbalanced shaft 140. The unbalanced driven gear 200 that is spinning rotates the unbalanced shaft 140 connected with the unbalanced driven gear 200. The unbalanced shaft 140 is formed parallel to the input shaft 420. The decelerator generating the booming sound creates vibrations whenever the unbalanced shaft 140 rotates.

In other words, as the rotation speed of the unbalanced shaft 140, as shown in FIG. 3, increases, the vibration frequency increases together in proportion to the rotation speed of the unbalanced shaft 140, and the vibration frequency can be changed by varying the rotation speed of the unbalanced shaft 140.

Also, the method of varying the rotation speed of the unbalanced shaft 140 includes a method of varying the gear ratio between the unbalanced drive gear 300 and the unbalanced driven gear 200. If the gear ratio is set to be high, a booming sound of a relatively high frequency tone can be created, and on the contrary, if the gear ratio is set to be low, a booming sound of a relatively low frequency tone can be created.

Also, the strength of the booming sound can be changed by varying the size of the unbalanced mass 120. If the unbalanced mass 120 is larger, a higher sound pressure can be created, so the booming sound can thereby be louder. However, if the unbalanced mass 120 is smaller, the sound pressure is created to be lower, so a low sound can be created.

As described above, the tone or volume of a booming sound can be controlled according to the characteristics of the motor-driven vehicle by varying the unbalanced mass 120, the rotation speed of the unbalanced shaft 140, and the gear ratio between the unbalanced drive gear 200 and the unbalanced driven gear 300. Also, if oil pressure is not formed in the decelerator like a manual transmission, in an exemplary embodiment of the present invention, a bearing 160 such as a wheel bearing can be used for supporting the unbalanced shaft 140. In a case in which an automatic transmission is applied to the electric vehicle, oil pressure is formed by a hydraulic pump, so a metal bearing, such as a bearing 160, can be adopted for supporting the unbalanced shaft 140.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A decelerator for generating a booming sound, comprising:
an input shaft connected with a motor;
an input gear engaged with the input shaft; and
an output gear mated with the input gear, wherein the motor controls the vehicle speed and delivers torque of the output gear wherein it further comprises an unbalanced drive gear installed on the input shaft spaced a predetermined distance from the input gear,
an unbalanced driven gear mated with the unbalanced drive gear, and
an unbalanced module connected with the unbalanced driven gear and having an unbalanced mass.

2. A decelerator for generating a booming sound of claim 1, wherein the unbalanced module comprises an unbalanced shaft connected with the unbalanced driven gear, an unbalanced mass adhered on a side of the unbalanced shaft, and a bearing installed on the exterior circumference of the unbalanced shaft and supporting the unbalanced shaft.

3. A decelerator for generating a booming sound of claim 1, wherein the booming sound is adjusted by the rotation speed of the unbalanced shaft.

4. A decelerator for generating a booming sound of claim 2, wherein the booming sound is adjusted by the rotation speed of the unbalanced shaft.

5. A decelerator for generating a booming sound of claim 3, wherein the rotation speed of the unbalanced shaft is adjusted by the gear ratio between the unbalanced drive gear and the unbalanced driven gear.

6. A decelerator for generating a booming sound of claim 4, wherein the rotation speed of the unbalanced shaft is adjusted by the gear ratio between the unbalanced drive gear and the unbalanced driven gear.

7. A decelerator for generating a booming sound of claim 1, wherein the booming sound is adjusted by the weight of the unbalanced mass.

8. A decelerator for generating a booming sound of claim 2, wherein the booming sound is adjusted by the weight of the unbalanced mass.

9. A decelerator for generating a booming sound of claim 2, wherein the bearing is either a ball bearing or a metal bearing.

10. A decelerator for generating a booming sound, comprising:
a shaft connected with a motor;
a first gear engaged with the shaft; and
an second gear mated with the first gear, wherein the motor controls the vehicle speed and delivers torque of the second gear wherein the second gear further comprises an unbalanced third gear installed on the shaft spaced a predetermined distance from the first gear,
an unbalanced fourth gear mated with the unbalanced third gear, and
an unbalanced module connected with the unbalanced fourth gear and having an unbalanced mass embodied therein.
